(19) United States
(12) Patent Application Publication
(10) Pub. No.: US 2026/0291758 A1
(43) Pub. Date: Sep. 24, 2026

(54) TRUST LEVEL COMPUTATION FOR AN END ENTITY

(71) Applicant: HEWLETT PACKARD ENTERPRISE DEVELOPMENT LP, Spring, TX (US)

(72) Inventors: Varsha Aiyappa Chovanda, Galway (IE); James Maguire, Galway (IE); Steven Roscio, Monument, CO (US)

(21) Appl. No.: 19/083,780

(22) Filed: Mar. 19, 2025

(51) Int. Cl. H04L 9/32

(52) U.S. Cl. CPC H04L 9/3268

(57) ABSTRACT

In some examples, a security system receives a certificate request from an end entity for a certificate for access to a computing environment. The security system computes a trust level for the end entity based on a plurality of factors, the plurality of factors including a first factor relating to a protected key for the end entity. The security system includes the computed trust level in a certificate generated for the certificate request, and sends the certificate including the computed trust level from the security system to the end entity. The computed trust level affecting access control for the end entity in the computing environment.

### BACKGROUND

An end entity can access resources or services of a computing environment. Examples of the computing environment include a data center, a cloud environment, a server environment, a communication network, or any other type of computing environment.

### BRIEF DESCRIPTION OF THE DRAWINGS

Some implementations of the present disclosure are described with respect to the following figures.

FIG. 1 is a block diagram of a computing environment including a trust establishment system, according to some examples.

FIG. 2 is a flow diagram of an end entity authentication process, according to some examples.

FIG. 3 is a flow diagram of a trust level adjustment process based on channel security, according to some examples.

FIG. 4 is a flow diagram of a trust level adjustment process based on how a private key is generated, according to some examples.

FIG. 5 is a flow diagram of a trust level adjustment process based on how a private key is protected, according to some examples.

FIG. 6 is a flow diagram of a trust level adjustment process based on key attributes, according to some examples.

FIG. 7 is a flow diagram of a trust level adjustment process based on a remote certification procedure, according to some examples.

FIG. 8 is a block diagram of a storage medium storing machine-readable instructions according to some examples.

FIG. 9 is a block diagram of a system according to some examples.

FIG. 10 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An end entity seeking access to a computing environment is to be authenticated. The end entity can provide a credential or a certificate to perform the authentication. If not authenticated, the end entity is denied access to the computing environment.

In some examples, identity authentication is a binary operation, in which an end entity seeking access to a computing environment is either authenticated or not authenticated. However, such a binary authentication mechanism does not distinguish between different levels of access that may be offered to end entities seeking access to the computing environment. The binary authentication mechanism lacks flexibility and may prevent end entities from accessing services of the computing environment that otherwise should be granted.

In accordance with some implementations of the present disclosure, a security system is able to assign different trust levels to end entities based on various trust factors, including any or some combination of the following: a channel security for a communication channel between an end entity and the security system; how a private key for the end entity is generated; how the private key for the end entity is protected; attributes of the private key; and a remote authentication procedure requested for the end entity. Although some example trust factors are listed above, other examples may employ additional or alternative trust factors. The different trust levels can trigger respective different access control processes in the computing environment for end entities.

For example, a first access control process for a first trust level can apply automated actions for an end entity assigned the first trust level, such as by using artificial intelligence (AI) control or rule-based control. A second access control process for a second trust level can provide access to restricted resources to an end entity assigned the second trust level. A third access control process for a third trust level can set geographic restrictions in granting access to restricted resources to an end entity assigned the third trust level. A fourth access control process for a fourth trust level can trigger manual checks by authorized personnel to determine whether an end entity assigned the fourth trust level can have any access to the computing environment. Although a specific quantity of trust levels and examples of access control processes are listed, in other examples, different quantities of trust levels can be assigned, and different types of access control processes can be employed for the trust levels.

An “end entity” can refer to a program, a virtual compute entity (e.g., a virtual machine (VM) or a container), or an electronic device that seeks access to a computing environment. The end entity may store a protected key, such as a secret key (used in a symmetric encryption algorithm) or a private key of a public-private key pair (used in an asymmetric encryption algorithm). The end entity may issue a certificate request, and a certificate may be assigned to the end entity in response to the certificate request. An example of a certificate request is a certificate signing request (CSR) described in a TPM (Trusted Platform Module) 2.0 Keys for Device Identity and Attestation document provided by the Trusted Computing Group (TCG). In other examples, other types of requests for certificates may be employed.

A certificate includes information to manage identity and security in a computing environment that includes multiple entities that interact with one another. A certificate can be a digital certificate, such as an X.509 certificate according to the X.509 Public Key Infrastructure (PKI) standard.

A “cryptographic device identity” (or more simply a “device identity”) can refer to an identity of an entity (in this case an end entity) that is cryptographically protected and is used as an authentication credential of the entity. An example of a cryptographic device identity is a Device Identity (DevID) certificate, such as an Initial DevID (IDevID) certificate installed in an end entity at the time of creation (e.g., manufacture, pre-ship configuration, etc.) of the end entity. Another example of a cryptographic device identity is a Local DevID (LDevID) certificate generated at a later time (after the creation of the end entity). A further example of a cryptographic device identity is a System DevID (SDevID) certificate, which is associated with a system that includes multiple modules, where each module has its own IDevID certificate or LDevID certificate. DevIDs are explained further in the Institute of Electrical and Electronics Engineers (IEEE) 802.1AR Secure Device Identity standard.

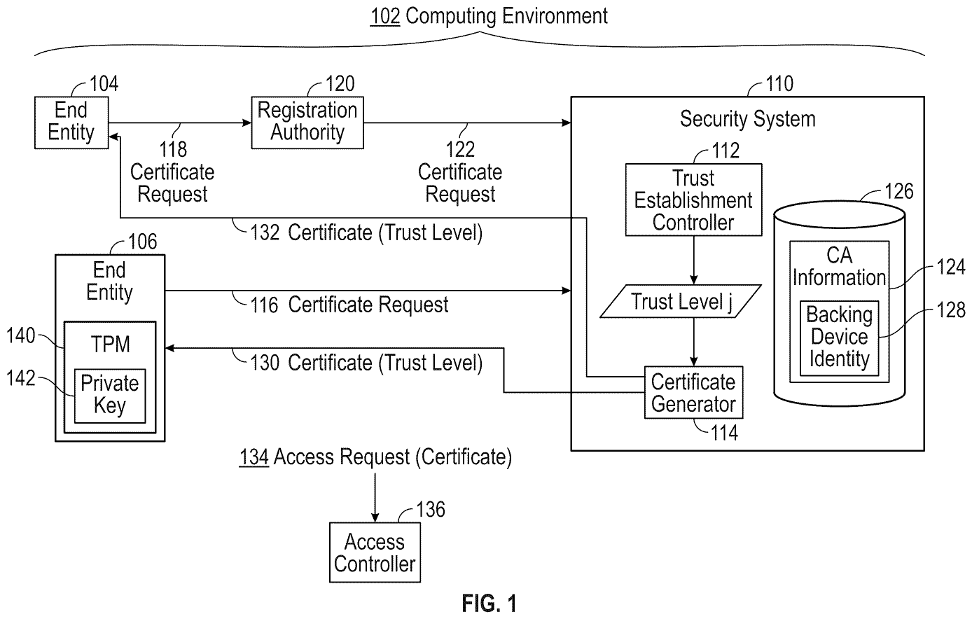

FIG. 1 is a block diagram of a computing environment 102, such as a data center, a cloud environment, a server environment, a communication network, or any other type of computing environment. The computing environment 102 includes various resources or services that may be accessed by end entities, including end entities 104 and 106. Examples of resources include processing resources, storage resources, communication resources, and/or other types of resources. Examples of services that can be provided include application services, web services, and/or other types of services.

The computing environment 102 also includes a security system 110, which can be implemented using one or more computers. The security system 110 is used to establish a trust level for an end entity seeking access to a resource or service of the computing environment 102. The security system 110 includes a trust establishment controller 112 to generate trust levels in response to certificate requests from end entities. The security system 110 also includes a certificate generator 114 to generate certificates in response to certificate requests from end entities. The certificate generator 114 performs tasks of a certification authority (CA), which is an entity that issues certificates.

In some examples, the security system 110 may be part of the CA. In further examples, the security system 110 may be part of both a CA and a registration authority (RA). An RA is an entity that acts as an intermediary between an end entity and a CA. An RA may perform services such as business policy checking, legal jurisdiction compliance checking, and verifying that a correct company or organization is associated with the end entity.

The trust establishment controller 112 and the certificate generator 114 may be implemented using one or more computers. In further examples, the trust establishment controller 112 and the certificate generator 114 may be implemented as machine-readable instructions executable on a processing resource.

The end entity 106 can issue a certificate request 116 to the security system 110. In the example shown, the certificate request 116 is issued directly by the end entity 106 to the security system 110, such as by transmitting the certificate request 116 over a network to the security system 110.

In contrast, the end entity 104 sends a certificate request 118 to an RA 120, which in turn forwards a corresponding certificate request 122 to the security system 110. Multiple RAs can exist between one or more end entities and the CA. In other examples, the RA 120 can be omitted.

A certificate request can include a CSR in some examples. The structure and elements of a CSR are described in TCG's TPM 2.0 Keys for Device Identity and Attestation document. In further examples, a CSR can use the Public-Key Cryptography Standards (PKCS) #10 format defined by Request for Comments (RFC) 2986, entitled “PKCS #10: Certification Request Syntax Specification Version 1.7,” or the CSR can have a format of a TBSCertificate structure defined by Request for Comments (RFC) 5280, entitled “Internet X.509 Public Key Infrastructure Certificate and Certificate Revocation List (CRL) Profile,” when supplemented with X.509 version 3 (v3) extensions for the certification elements. CSRs according to other formats can also be used in other examples.

The trust establishment controller 112 processes a certificate request (e.g., 116 or 122) received for an end entity. Based on the certificate request, the trust establishment controller 112 can determine whether the certificate request is to be accepted or denied. If the certificate request is accepted, the trust establishment controller 112 generates a trust level j for the end entity based on one or more of the trust factors discussed above.

The trust establishment controller 112 has access to CA information 124, which is stored in a data repository 126. The data repository 126 can be implemented with one or more storage devices. The CA information 124 may include a backing device identity 128 that can be used to authenticate an end entity. In some examples, the backing device identity is a backing DevID (such as an IDevID or factory SDevID). The backing DevID is often supplied alongside the CSR as an attribute of the communications channel that carries the CSR.

The trust level j produced by the trust establishment controller 112 is selected from among multiple trust levels, such as trust level 1, trust level 2, . . . , trust level N (N≥2). The trust level j assigned to an end entity is included in the signed portion of a certificate sent to the end entity that issued the certificate request. In FIG. 1, the certificate generator 114 sends, to the end entity 106, a certificate 130 that contains the trust level assigned the end entity 106. The certificate 130 is generated by the certificate generator 114 in response to the certificate request 116.

Similarly, the certificate generator 114 sends, to the end entity 104, a certificate 132 that contains the trust level assigned the end entity 104. The certificate 132 is generated by the certificate generator 114 in response to the certificate request 122. In other examples, the certificate generator 114 can send the certificate 132 to the RA 120, which in turn forwards the certificate 132 to the end entity 104.

To access a resource or service of the computing environment 102, an end entity can issue an access request 134 to an access controller 136 in the computing environment 102. The access controller 136, implemented with one or more computers, is an entity in the computing environment 102 that manages access to resources and services. The access controller 136 may include a firewall, a gateway, and so forth. Although shown as separate from the security system 110 in FIG. 1, the access controller 136 may be part of the security system 110 in other examples.

The access request 134 issued by the end entity includes a certificate received by the end entity from the security system 110. The certificate contains the trust level assigned to the end entity by the security system 110. Based on the trust level included in the certificate contained in the access request 134, the access controller 136 applies an access control process corresponding to the trust level.

As further shown in FIG. 1, the end entity 106 includes a Trusted Platform Module (TPM) 140, which is an example of a security processor for performing security operations in the end entity 106. The end entity 104 may similarly include a TPM or another type of security processor. A security processor (sometimes referred to as a security cryptoprocessor) can perform various hardware-based, security functions in a physical platform. The security functions of the security processor can include key and certificate management and generation. For example, the security processor can generate cryptographic keys used in security operations, where a cryptographic key can include a public-private key pair including a public key and the associated private key. Although reference is made to a TPM in some examples, more generally, techniques or mechanisms according to some examples of the present disclosure can use another type of a secure storage device, such as a secure nonvolatile memory in a management controller such as a Baseboard Management Controller (BMC). A secure storage device can be used as a secure key storage. A TPM is an example of a component that includes a secure key storage.

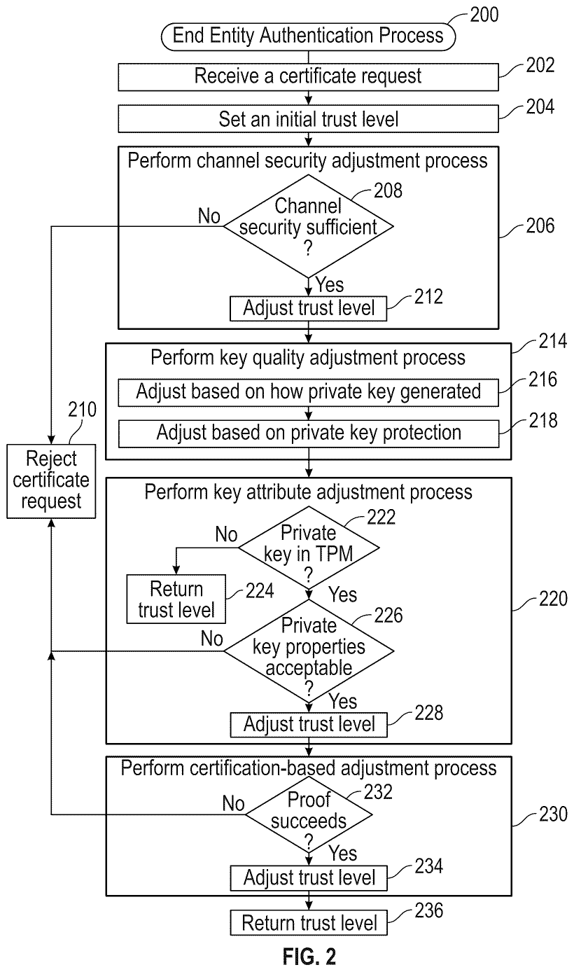

FIG. 2 is a flow diagram of an end entity authentication process 200 initiated by the security system 110 in response to a certificate request (e.g., a CSR) received (at 202) from an end entity. In response to the received certificate request, the trust establishment controller 112 of the security system 110 sets (at 204) an initial trust level for the end entity. In some examples, a trust level assigned to the end entity can be represented by a numerical value (referred to as a “numerical trust value”). Different numerical trust values (or different ranges of numerical trust values) can represent different trust levels. In other examples, a trust level can be represented by a categorical value (e.g., low, medium, high, grades such as A+ through F−, etc.), where the categorical value can be selected from a set of categorical values representing different trust levels. In the ensuing discussion, it is assumed that numerical trust values are used for defining a trust level for an end entity.

Table 1 below lists example initial trust values that can be set based on the type of endpoint authentication technique employed by the end entity when connecting to the security system 110.

TABLE 1

| Endpoint Authentication Type | Initial Trust Value |
|---|---|
| Indeterminate | 45 |
| Anonymous | 53 |
| Password | 62 |
| Registration Token | 65 |
| DevID | 72 |

In some examples, a higher numerical trust value indicates a higher trust level, while a lower numerical trust value indicates a lower trust level. The example initial trust values included in Table 1 are provided for purposes of illustration. In other examples, different initial trust values may be set by the trust establishment controller 112.

An endpoint authentication technique refers to a technique used to verify an end entity is who the end entity purports to be to a server, such as an RA or CA.

In some examples, a DevID-based endpoint authentication technique can be considered the most trusted endpoint authentication technique. As a result, the initial trust value assigned is the highest if the DevID-based endpoint authentication technique is used. The DevID-based endpoint authentication technique includes a client (e.g., an end entity) connecting to the RA or CA using a security protocol, such as a mutual transport layer security (mTLS) protocol, and providing a DevID (e.g., an IDevID, an SDevID, or an LDevID) as the client-side credentials for the connection. In some examples, the DevID provided may be owned by the end entity. In other examples, the DevID may be provided by an outer component (referred to as a “relay”). A relay refers to a client that is a component of a larger composed system, which sends a certificate request on behalf of another inner component (e.g., an end entity) of the composed system. The relay can be referred to as an “outer” component, since it is a component that has network access to the RA or CA. In examples where a relay is involved, there may be two DevIDs provided: the relay's DevID passed as part of the mTLS protocol, and the end entity's DevID.

A registration token-based endpoint authentication technique can be considered the second most trusted endpoint authentication technique. As a result, the initial trust value assigned is the second highest. The registration token-based endpoint authentication technique includes a client connecting to the RA or CA using at least a server-side TLS protocol, and providing a registration token for authentication. The registration token can include a short-lived shared secret between the client and the server (e.g., RA or CA). If a relay is involved, the relay forwards the registration token from the end entity along with the end entity's CSR to the security system 110.

A password-based endpoint authentication technique can be considered the third most trusted endpoint authentication technique. As a result, the initial trust value assigned is the third highest. The password-based endpoint authentication technique includes a client connecting to the RA or CA using the server-side TLS protocol, and providing a long-lived shared secret for authentication. The password is longer lived than a registration token. Note also that a registration token may be restricted to a relatively low number of uses, and the registration token may be restricted to use with a specific system or set of systems. A registration token is generated by an independent system, not by a user. Also, a registration token may encode an expiration time and check digits or characters.

An anonymous authentication technique can be considered the second least trusted endpoint authentication technique. As a result, the initial trust value assigned is the second lowest. With the anonymous authentication technique, a client does not proffer any identity. However, a server (e.g., the RA or CA) may provide an identity for the client. This identity is created by the server, not the client. The identity may be persisted for the lifetime of the client.

An indeterminate authentication technique refers to a connection by a client with a server where the server is unable to determine what authentication technique is used by the client. As a result, the initial trust value assigned is the lowest.

After the initial trust level has been set, the trust establishment controller 112 can adjust the trust level for the end entity using any or some combination of the trust factors discussed further above. FIG. 2 depicts a specific example of how adjustments are made using various trust factors. Note that in other examples, the adjustment of the trust level for the end entity can be performed in a different way. Further, the adjustments of the trust levels based on trust factors may be performed in a different order (different from the order shown in FIG. 2) in other examples.

The trust establishment controller 112 performs (at 206) a channel security adjustment process for adjusting a trust level based on the channel security of a communication channel between the end entity and the security system 110. Channel security refers to the confidentiality, integrity, and to a lesser degree, the resilience (availability) of the communication channel from the end entity to the security system 110.

The channel security adjustment process includes determining (at 208) whether the channel security is sufficient. If not, the certificate request is rejected (at 210). Examples of the channel security being insufficient include any or some combination of the following. First, the communication channel is a cleartext channel, e.g., no encryption is applied and no confidentiality is provided to protect the certificate request transmitted from the end entity to the security system 110. For example, the communication channel may include an unencrypted Transmission Control Protocol (TCP) connection between the end entity and the security system 110.

Second, the communication channel has no confidentiality, which is provided by a security protocol. An example of a security protocol providing sufficient confidentiality is the TLS version 1.2 or later protocol or the Secure Shell 2 (SSH-2) protocol, which provides a minimally acceptable method of data encryption to provide data confidentiality. Other security protocols may also provide sufficient confidentiality.

Third, the communication channel has no tamper check. For example, a tamper check may be provided if the communication channel offers data integrity using signatures, hashes, or similar techniques. For example, the TLS 1.2 or later protocol or the SSH-2 protocol provides data integrity.

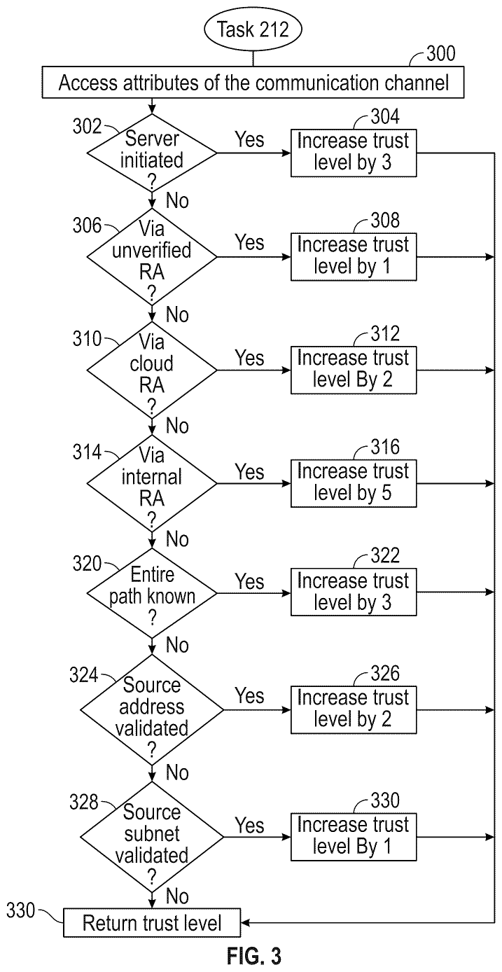

If the channel security adjustment process determines (at 208) that the channel security is sufficient (e.g., the communication channel is not cleartext, has confidentiality, and has tamper check), then the channel security adjustment process adjusts (at 212) the currently set trust level (which is the initial trust level set at 204 in FIG. 2) based on the channel security trust factor; i.e., the trust level is adjusted according to the channel security of the communication channel. Note that the channel security may be deemed sufficient if the communication channel uses the TLS version 1.2 or later or the SSH-2 protocol, along with approved cipher suites for data encryption. The adjustment (at 212) of the currently set trust level based on the channel security trust factor is depicted in FIG. 3.

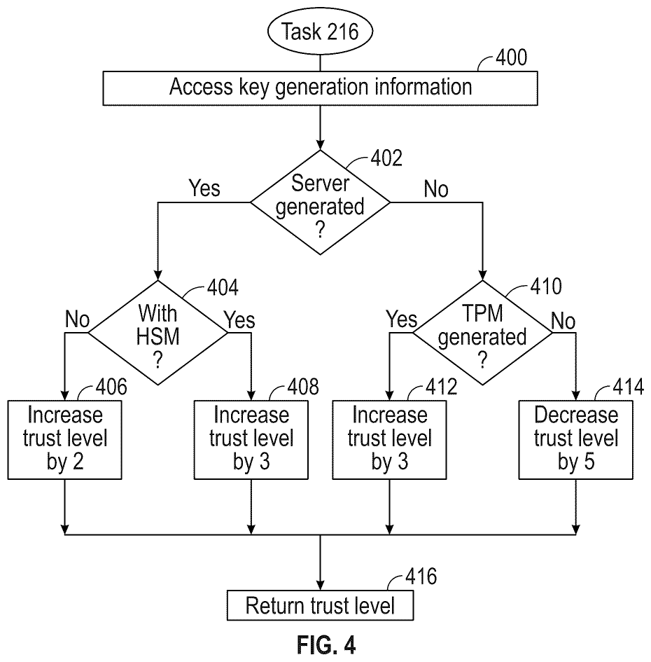

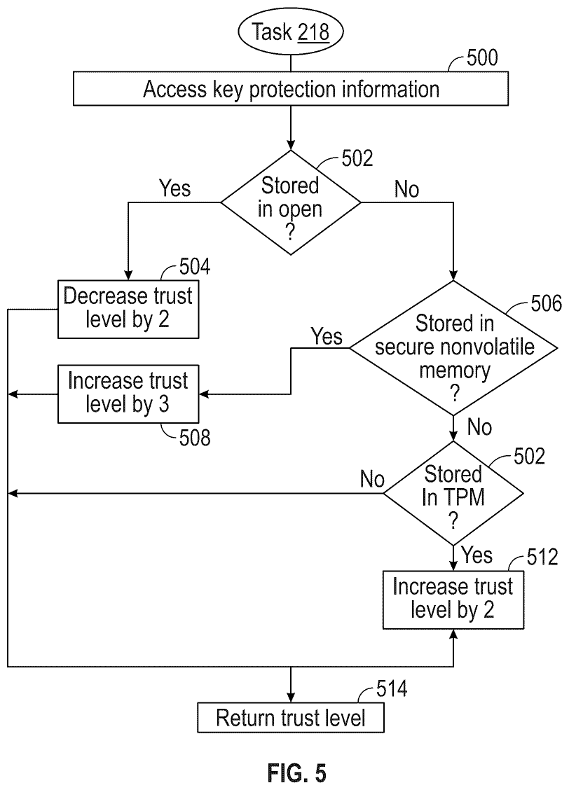

The trust establishment controller 112 performs (at 214) a key quality adjustment process for adjusting a trust level based on a key quality trust factor. The key quality adjustment process includes adjusting (at 216) the currently set trust level (e.g., after the adjustment at 210) based on how a private key was generated (depicted further in FIG. 4), and adjusting (at 218) the currently set trust level (e.g., after the adjustments at 212 and 214) based on the key protection provided for the private key (depicted further in FIG. 5). In other examples, task 218 may be performed before task 216. Although the present discussion refers to adjusting a trust level based a key quality trust factor associated with a private key, it is noted that similar techniques are applicable to other types of protected keys, such as a secret key used in a symmetric algorithm.

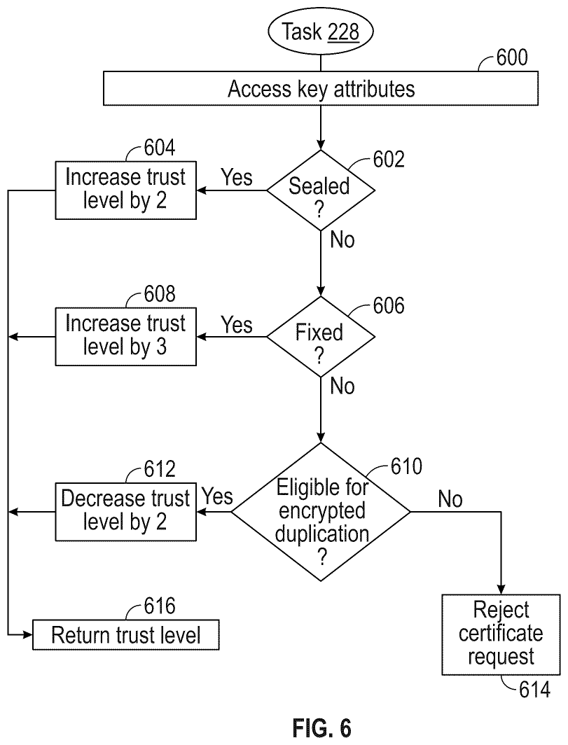

The trust establishment controller 112 performs (at 220) a key attribute adjustment process for adjusting a trust level based on a key attribute trust factor. The adjustment is based on key attributes of the private key for the end entity. Examples of key attributes are discussed further in connection with FIG. 6, which depicts how the trust level is adjusted based on key attributes of the private key.

The key attribute adjustment process determines (at 222) whether the private key is stored in a TPM (e.g., a private key 142 of the end entity 106 stored in the TPM 140 as shown in FIG. 1). Note that techniques or mechanisms according to some examples of the present disclosure are applicable to storage of a private key (or more generally, a protected key) in another type of secure key storage. If the private key is not stored in a TPM, then the key attribute adjustment process returns (at 224) the currently set trust level without any further adjustment. This returned trust level is trust level j in FIG. 1, for example, which is provided to the certificate generator 114 for producing a certificate that includes the trust level.

However, if the private key is stored in a TPM, the key attribute adjustment process determines (at 226) whether properties associated with the private key are acceptable. If the properties associated with the private key are not acceptable, then the key attribute adjustment process rejects (at 210) the certificate request. If the properties associated with the private key are acceptable, then the key attribute adjustment process adjusts (at 228) the currently set trust level based on the key attributes (e.g., after the adjustments at 216 and 218). The adjustment based on the key attributes is further depicted in FIG. 6.

The following refers to some examples of how properties associated with the private key are unacceptable. For example, a property associated with the private key is unacceptable if any key attribute of the private key is corrupted or invalid. As another example, a property associated with the private key is unacceptable if no anti-hammer protection is provided for the private key. A hammer attack refers to an attack in which an entity makes repeated attempts at circumventing the protections of the TPM to weaken or breach the protections. The anti-hammer protection protects the TPM against such attacks. A TPM that operates according to the TPM 2.0 Specification (or later) is considered to have an adequate anti-hammer protection.

Further, task 226 may determine how the private key is used, and whether such usage is improper. In an example, if the certificate request is for a DevID certificate, then the key usage should not be restricted. A restricted key usage indicates that the private key can be used only on data generated by the TPM in the end entity. If the certificate request is for a DevID certificate, and the certificate request specifies that the key usage is restricted, then the trust establishment controller 112 rejects the certificate request.

In another example, if the certificate request is for a Local Attestation Key (LAK) certificate, then the key usage should be restricted. The LAK certificate is used for attestation of the end entity to confirm the integrity of the components (program components and/or hardware components) of the end entity. If the certificate request is for an LAK certificate, and the certificate request specifies that the key usage is not restricted, then the trust establishment controller 112 rejects the certificate request.

In a further example, if the certificate request specifies a key usage that does not allow signing of information, then the trust establishment controller 112 rejects the certificate request.

In an additional example, if the certificate request specifies that the key usage is set to decrypt only, then the trust establishment controller 112 rejects the certificate request. A key usage set to decrypt only means that a key is restricted to decrypting information and cannot be used for signing.

The trust establishment controller 112 performs (at 230) a certification-based adjustment process for adjusting a trust level based on a proof (e.g., a TCG proof) submitted with the certificate request. A TCG proof is information coupled with a CSR defined by the TCG and contains a cryptographic proof that a DevID private key (e.g., an LDevID private key) resides in a TPM. TCG proofs are described in the TPM 2.0 Keys for Device Identity and Attestation document. More generally, a proof in a certificate request contains information that is useable to verify a private key and certain attributes regarding where the private key is stored.

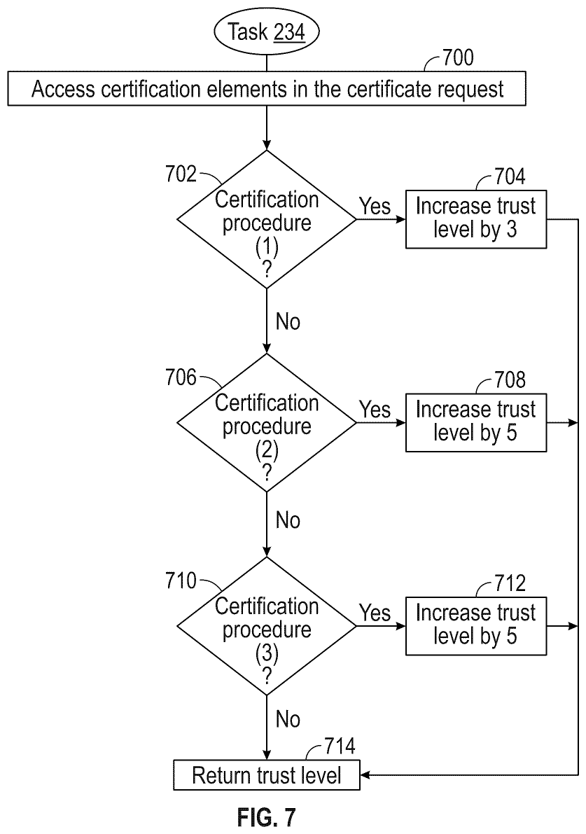

The certification-based adjustment process includes determining (at 232) if the proof succeeds. If not, the certificate request is rejected (at 210). However, if the proof succeeds, the certification-based adjustment process adjusts (at 234) the currently set trust level (e.g., after the adjustment at 230) based on the proof (discussed further in connection with FIG. 7). The adjusted trust level is returned (at 236) and output to the certificate generator 114 of FIG. 1.

In some examples, to determine (at 232) whether the proof succeeds, the certification-based adjustment process can extract a LDevID public key (which is part of the LDevID public-private key pair that also includes the LDevID private key) from the TCG proof. The certification-based adjustment process determines whether the signature of the TCG proof is valid. If not, the certificate request is rejected. If the signature is valid, the certification-based adjustment process determines whether an initial attestation key (IAK) certificate in the certificate request (e.g., a CSR) is valid. The IAK certificate can be used to perform attestation of the end entity to confirm the integrity of the components (program components and/or hardware components) of the end entity.

If the IAK certificate is invalid, the certificate request is rejected. If the IAK certificate is valid, the certification-based adjustment process can verify other elements, including public area attributes of the LDevID certificate, for example. Examples of the public area attributes of the LDevID certificate include any or some combination of the following: FixedTPM (which indicates that the LDevID key cannot be duplicated); FixedParent (which indicates that the key may be copied or migrated only if a parent key may be duplicated); and so forth. If the other elements are not verified, the certificate request is rejected.

In further examples, to determine (at 232) whether the proof succeeds, the certification-based adjustment process can perform a determination of an identity linkage. The identity linkage considers whether a device identity (e.g., LDevID, SDevID, or another identity) being requested for the end entity is consistent with an identity from the backing DevID or a registration token (proof-of-linkage). If the end entity is part of a larger composed system, the certification-based adjustment process can perform a determination of whether multiple components (including the end entity and other components) are all part of the same system (proof-of-composition). If the identity linkage cannot be proven, the certificate request is rejected. In some examples, the identity linkage can check whether the device identity being requested matches the identity from the backing DevID or a registration token. In other examples, the check can use a heuristic algorithm or an inventory lookup composition check. For example, the check can pass if the requested device identity is for an end entity that is part of a larger system identified by the backing DevID.

Proof-of-linkage is performed to check that the identity from the backing DevID or the registration token and the requested identity refer to the same system. This may be performed heuristically, such as by checking that the manufacturer identifiers, part numbers, and serial numbers are the same. However, an RA may check a manufacturing inventory for the end entity to verify the proof-of-linkage, and supply a result of the check to the security system 110. The manufacturing inventory includes an inventory manifest that lists parts of a system, which can be identified by serial numbers and part numbers of the parts.

Proof-of-composition may also be performed heuristically, such as by checking that an identity of the larger composed system in the backing DevID or registration token matches the requested identity. Proof-of-composition may also be performed by checking a manufacturing inventory for the system.

FIG. 3 is a flow diagram of task 212 in FIG. 2, which adjusts the currently set trust level based on the channel security trust factor. Task 212 includes accessing (at 300) attributes of the communication channel, which may be stored in the security system 110, for example.

Task 212 determines (at 302), based on attributes of the communication channel, whether the communication channel is server initiated to the end entity. For example, the communication channel between the end entity and the security system 110 may have been initiated by the security system 110 (the server). A higher assurance about the client is indicated when the communication channel is initiated by the server to the client at a known, fixed network address (e.g., an Internet Protocol (IP) address). If the communication channel is server initiated, task 212 increases (at 304) the currently set trust level by 3.

In the present discussion accompanying FIGS. 2-7, various example incremental values (positive or negative values) are provided to illustrate relative magnitudes of adjustment under different conditions. In other examples, different example incremental values can be used to adjust trust levels.

If the communication channel is not server initiated, task 212 determines (at 306), based on the attributes of the communication channel, whether the communication channel is via an unverified RA. An unverified RA is an RA that has not been previously determined to be trusted. If the communication channel is via the unverified RA, task 212 increases (at 308 the currently set trust level by 1.

If the communication channel is not via an unverified RA, task 212 determines (at 310), based on the attributes of the communication channel, whether the communication channel is via a cloud RA. The cloud RA is an RA hosted in an external public cloud. The cloud RA can be considered a medium trust RA. If the communication channel is via the cloud RA, task 212 increases (at 312) the currently set trust level by 2.

If the communication channel is not via a cloud RA, task 212 determines (at 314), based on the attributes of the communication channel, whether the communication channel is via an internal RA, such as an RA in an internal network of an organization. The internal RA can be considered a higher trust RA. If the communication channel is via the internal RA, task 212 increases (at 316) the currently set trust level by 5.

Task 212 further determines (at 320) whether an entire network path of the communication channel between the end entity and the security system 110 is known. The communication channel may transit through multiple intermediary communication nodes (hops), such as switches, routers, gateways, or other communication nodes, which may be part of one or more networks possibly across different countries. If the trust establishment controller 112 has information about each intermediary communication node through which the communication channel is established, then the entire network path of the communication channel is known. This allows the trust establishment controller 112 to determine that the network path is not traversing prohibited regions or through less secure communication nodes. If the entire network path of the communication channel is known, task 212 increases (at 322) the currently set trust level (e.g., set according to 304, 308, 312, 316, or 318) by 3.

If the entire network path of the communication channel is not known, task 212 determines (at 324) whether a source address of the communication channel is validated. The source address can be a source IP address of the end entity on the communication channel. The source address is validated if a verification process has been applied to verify the source address so that it can be trusted. If the source address of the communication channel is validated, task 212 increases (at 326) the currently set trust level by 2.

If the source address of the communication channel is not validated, task 212 determines (at 328) whether a source subnet (e.g., defined by a range of IP addresses) to which the end entity is connected is validated. For example, in some cases, an IP subnet instead of specific IP addresses of end entities are validated with a verification process. If the source address of the communication channel is validated, task 212 increases (at 330) the currently set trust level by 1.

If the checks at 302, 306, 310, 314, 320, 324, and 328 all return false, then task 212 makes no change to the currently set trust level.

The trust level derived according to FIG. 3 is returned (at 330).

FIG. 4 is a flow diagram of task 216 in FIG. 2, which adjusts the currently set trust level based on how the private key for the end entity is generated. Note that the private key is usually generated as part of a public-private key pair that also includes the public key for the end entity. Task 216 includes accessing (at 400) key generation information that describes how the private key is generated. The key generation information may be obtained or inferred from the certificate request and/or may be stored at the security system 110, for example.

Different key generation techniques impact the trust level of the end entity's identity, since the strength, confidentiality, integrity, resilience, and exportability of the private key provide the foundations of a secure identity.

Task 216 determines (at 402) whether the private key is server generated. “Server generated” means that the private key is generated by a server, such as a CA. If the private key is server generated, task 216 determines (at 404) whether the private key is generated with a hardware security module (HSM). An HSM can be coupled to the CA. For example, the HSM may be a standalone computing device or an adapter card that can be plugged into the CA. The CA may generate the private key in situ or the CA may employ an HSM to generate the private key. Generating the private key with the HSM that is external to the CA and that does not expose the private key indicates a higher level of security for the private key.

If the private key is server generated without using an HSM, task 216 increases (at 406) the currently set trust level by 2. If the private key is server generated using the HSM, task 216 increases (at 408) the currently set trust level by 3.

If the private key is not server generated, task 216 determines (at 410) whether the private key is generated with a TPM at the end entity, such as with the TPM 140 at the end entity 106 of FIG. 1. If the private key is generated with the TPM at the end entity, task 216 increases (at 412) the currently set trust level by 3.

However, if the private key is not server generated (as determined at 402) and the private key is not generated at the end entity using a TPM, task 216 decreases (at 414) the currently set trust level by 5. The private key not server generated and not generated using a TPM indicates that the private key is generated in the open or using a relatively low security technique, such as by a central processing unit (CPU) of the end entity.

Task 216 returns (at 416) the adjusted trust level. Note that if a symmetric or post-quantum-computing (PQC) algorithm is used, a secret key may be evaluated in similar fashion as depicted in FIG. 4.

FIG. 5 is a flow diagram of task 218 in FIG. 2, which adjusts the currently set trust level based on how the private key for the end entity is protected. Note that even if the private key was securely generated, the private key may be compromised if the private key is not sufficiently protected.

Task 218 accesses (at 500) key protection information to determine how the private key is stored and protected. The key protection information may be obtained or inferred from the certificate request and/or may be stored at the security system 110, for example.

Task 218 determines (at 502), based on the key protection information, whether the private key is stored in the open, such as in the end entity's file system or otherwise stored in an insecure key storage (e.g., an unprotected nonvolatile memory). If the private key is stored in the open, task 218 decreases (at 504) the currently set trust level by 2. The private key is considered to be stored in the open if an operating system (OS) or an application program can read the private key in plaintext.

If the private key is not stored in the open, task 218 determines (at 506) whether the private key is stored in a secure nonvolatile memory in the end entity. The private key is considered to be stored in a secure nonvolatile memory if the private key is not available to the OS but may be available to a boot code or a BMC. If the private key is stored in the secure nonvolatile memory, task 218 increases (at 508) the currently set trust level by 3.

If the private key is not stored in a secure nonvolatile memory, task 218 determines (at 510) whether the private key is stored in a TPM in the end entity. If the private key is stored in the TPM, task 218 increases (at 512) the currently set trust level by 2. Note that in the case where the private key is stored in the TPM, further adjustment of the trust level would be performed according to FIG. 6, which may increase the trust level further.

Task 218 then returns (at 514) the adjusted trust level.

FIG. 6 is a flow diagram of task 228 in FIG. 2, which adjusts the currently set trust level based on the key attributes. Task 228 accesses (at 600) key attributes, which may be obtained or inferred from the certificate request, for example.

Task 228 determines (at 602), based on the key attributes, whether the private key is sealed. The private key (which is stored in the TPM) is sealed if the private key is accessible only after confirming that measurements (obtained at boot time of the end entity) of the state of the hardware and the OS of the end entity are valid. A measurement can be derived by applying a cryptographic hash function on the state, for example. If the private key is sealed, task 228 increases (at 604) the currently set trust level by 2.

If the private key is not sealed, then task 228 determines (at 606), based on the key attributes, whether the private key is fixed. The private key being fixed means that the private key is non-exportable from the TPM. The private key is non-exportable if the private key cannot be duplicated and provided outside the TPM.

If the private key is fixed, task 228 increases (at 608) the currently set trust level by 3. If the private key is not fixed (i.e., the private key is exportable), task 228 determines (at 610), based on the key attributes, whether the private key is eligible for encrypted duplication. Encrypted duplication refers to an exportation of the private key after the private key has been encrypted. If the private key is eligible for encrypted duplication, duplication of the private key that has not been encrypted is not allowed. If the private key is eligible for encrypted duplication, task 228 decreases (at 612) the currently set trust level by 2.

However, if the private key is not fixed (as determined at 606) and encrypted duplication is not enforced (as determined at 610) (which means that the private key is exportable without encryption), then task 228 rejects (at 614) the certificate request.

Assuming that the certificate request is not rejected, task 228 returns (at 616) the trust level as adjusted according to FIG. 6.

FIG. 7 is a flow diagram of task 234 in FIG. 2, which adjusts the currently set trust level based on a proof (e.g., a TCG proof) submitted with the certificate request. Task 234 accesses (at 700) certification elements in the certificate request. As discussed further above, the structure and elements of a CSR are described in TCG's TPM 2.0 Keys for Device Identity and Attestation document. In further examples, a CSR can have a format of a TBSCertificate structure defined by Request for Comments (RFC) 5280, entitled “Internet X.509 Public Key Infrastructure Certificate and Certificate Revocation List (CRL) Profile,” when supplemented with X.509 version 3 (v3) extensions for the certification elements.

In some examples, different certification procedures can be used to perform a remote certification for verifying, e.g., by the CA or RA, the private key and TPM attributes before issuing a device identity certificate (e.g., an LDevID certificate). In some examples, TCG's TPM 2.0 Keys for Device Identity and Attestation document describes three certification procedures, including (1) a certification procedure that includes the creation of an LAK certificate based on a manufacturer-installed IAK certificate, (2) a certification procedure that includes the creation of an LDevID certificate based on a manufacturer-installed IAK certificate, or (3) a certification procedure that includes the creation of an LDevID certificate based on an LAK certificate.

FIG. 7 refers to the above specific example certification procedures. In other examples, trust level adjustments can be based on different certification procedures.

Task 234 determines (at 702), based on the certification elements in the certificate request, whether certification procedure (1) is used. If so, task 234 increases (at 704) the currently set trust level by 3.

If certification procedure (1) is not used, task 234 determines (at 706), based on the certification elements in the certificate request, whether certification procedure (2) is used. If so, task 234 increases (at 708) the currently set trust level by 5.

If certification procedures (1) and (2) are not used, task 234 determines (at 710), based on the certification elements in the certificate request, whether certification procedure (3) is used. If so, task 234 increases (at 712) the currently set trust level by 5.

Task 234 returns (at 714) the adjusted trust level.

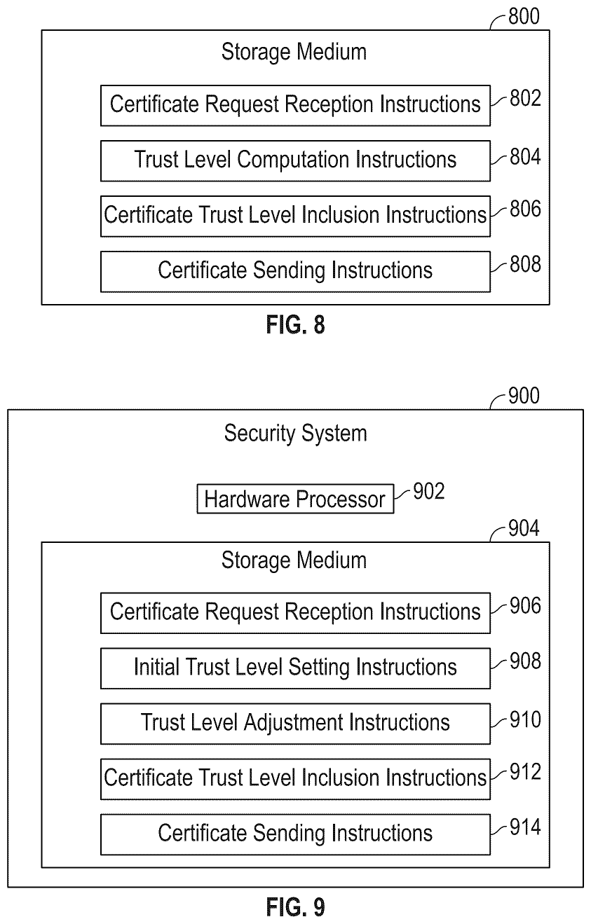

FIG. 8 is a block diagram of a non-transitory machine-readable or computer-readable storage medium 800 storing machine-readable instructions that upon execution cause a security system to perform various tasks according to some examples of the present disclosure. The security system may be part of a CA.

The machine-readable instructions include certificate request reception instructions 802 to receive, at the security system, a certificate request from an end entity for a certificate for access to a computing environment. The certificate request may include a CSR, for example.

The machine-readable instructions include trust level computation instructions 804 to compute a trust level for the end entity based on a plurality of factors, including any of the trust factors discussed further above. For example, the trust factors can include a first factor relating to a protected key for the end entity. The first factor may relate to how the protected key is generated and/or how the protected key is protected. The protected key can be a private key of a public-private key pair, or a secret key used in a symmetric algorithm.

The machine-readable instructions include certificate trust level inclusion instructions 806 to include the computed trust level in a certificate generated for the certificate request. The certificate may be a certificate requested by a CSR, for example.

The machine-readable instructions include certificate sending instructions 808 to send the certificate including the computed trust level from the security system to the end entity. The computed trust level affects access control for the end entity in the computing environment, which may be performed by the access controller 136 of FIG. 1, for example.

In some examples, the trust level is computed further based on a second factor relating to a remote certification procedure specified in the certificate request. The remote certification procedure may be any of certification procedures (1), (2), or (3) depicted in FIG. 7, for example.

In some examples, the computed trust level is adjusted by different amounts based on which of a plurality of different remote certification procedures are specified in the certificate request, such as by certification elements in a CSR.

In some examples, the security system can compute the trust level by setting an initial trust level for the end entity based on a further factor relating to a type of endpoint authentication used by the end entity when connecting to the security system. The security system derives the computed trust level based on an adjustment from the initial trust level according to the remaining one or more factors of the plurality of factors. The remaining one or more factors can include a channel security for a communication channel between an end entity and the security system; how the protected key for the end entity is generated; how the protected key for the end entity is protected; or a remote authentication procedure requested for the end entity.

In some examples, the type of endpoint authentication is selected from one or more of an anonymous authentication of the end entity, a password-based authentication of the end entity, a registration token-based authentication of the end entity, or a cryptographic device identity-based authentication of the end entity, and wherein the initial trust level is settable to different values for respective different types of endpoint authentications.

In some examples, the security system can compute the trust level further based on a further factor relating to channel security used for a communication channel between the end entity and the security system

In some examples, the security system can adjust the computed trust level based on one or more of whether the communication channel is initiated by the security system, a trust level of an RA (e.g., an unverified RA, a cloud RA, or an internal RA) between the end entity and the security system, or information for a network path of the communication channel between the end entity and the security system.

In some examples, the security system can determine a type of security protocol used to implement the channel security. The computing of the trust level is responsive to the type of security protocol satisfying a criterion, e.g., the security protocol is TLS version 1.2 or later, or SSH-2, for example. More generally, the criterion relates to one or more of integrity, confidentiality, tamper resistance, or resilience of the communication channel.

In some examples, the first factor relates to one or more of how the protected key is generated or how the protected key is protected.

In some examples, a protection of the protected key is selected from among an open key protection in which the protected key is stored in an insecure storage location (e.g., part of a file system), a nonvolatile memory protected key protection in which the protected key is stored in a secure nonvolatile memory, or a security processor key protection in which the protected key is stored in a security processor (e.g., a TPM).

In some examples, the security system can set the computed trust level based on a determination that the protected key is stored in a security processor.

In some examples, the security system can adjust the computed trust level to a selected level of different levels corresponding to the protected key being sealed, the protected key being non-exportable, or the protected key being exportable but encrypted.

In some examples, the security system can determine whether to reject the certificate request based on a key usage indicated in the certificate request for the protected key.

In some examples, the security system can reject the certificate request based on determining that the certificate is for a DevID certificate and the key usage is restricted, or reject the certificate request based on determining that the certificate is for an AK certificate and the key usage is not restricted.

In some examples, the security system can reject the certificate request based on determining that the key usage does not allow signing or the key usage is decrypt only.

In some examples, the security system can determine whether a cryptographic identity (e.g., IDevID certificate or SDevID certificate) requested by the certificate request is consistent with an identity in a backing device identity (e.g., backing DevID) or a registration token. The security system can reject the certificate request based on determining that the cryptographic identity requested by the certificate request is not consistent with the identity in the backing device identity or the registration token.

FIG. 9 is a block diagram of a security system 900 according to some examples of the present disclosure. The security system 110 of FIG. 1 is an example of the security system 900.

The security system 900 includes a hardware processor 902 (or multiple hardware processors). A hardware processor can include a microprocessor, a core of a multi-core microprocessor, a microcontroller, a programmable integrated circuit, a programmable gate array, or another hardware processing circuit.

The security system 900 further includes a storage medium 904 storing machine-readable instructions executable on the hardware processor 902 to perform various tasks. Machine-readable instructions executable on a hardware processor can refer to the instructions executable on a single hardware processor or the instructions executable on multiple hardware processors.

The machine-readable instructions in the storage medium 904 include certificate request reception instructions 906 to receive a certificate request from an end entity for a certificate for access to a computing environment. The certificate request may be a CSR, for example.

The machine-readable instructions in the storage medium 904 include initial trust level setting instructions 908 to set an initial trust level for the end entity based on a first factor relating to a type of endpoint authentication used by the end entity when connecting to the security system. Different initial trust levels are set for different types of endpoint authentications.

The machine-readable instructions in the storage medium 904 include trust level adjustment instructions 910 to adjust the initial trust level for the end entity that includes an adjustment based on a second factor relating to a protected key for the end entity, the adjustment producing an adjusted trust level. The second factor can relate to how the protected key is generated and/or how the protected key is protected.

The machine-readable instructions in the storage medium 904 include certificate trust level inclusion instructions 912 to include the adjusted trust level in a certificate generated for the certificate request.

The machine-readable instructions in the storage medium 904 include certificate sending instructions 914 to send the certificate including the adjusted trust level from the security system to the end entity, the adjusted trust level affecting access control for the end entity in the computing environment. For example, the access controller 136 can implement different access processes for different trust levels.

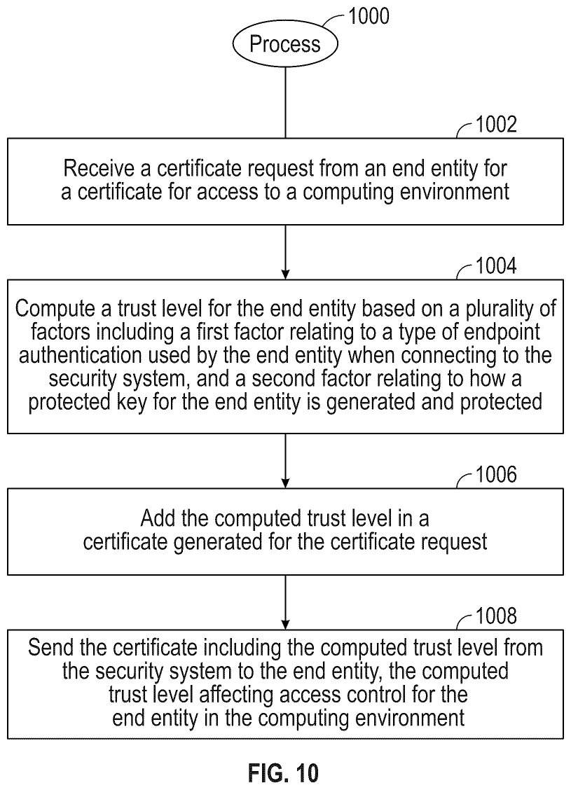

FIG. 10 is a flow diagram of a process 1000 according to some examples of the present disclosure. The process 1000 may be performed by the security system 110 or 900 of FIG. 1 or 9, respectively.

The process 1000 includes receiving (at 1002) a certificate request from an end entity for a certificate for access to a computing environment. The certificate can be included in an access request submitted by the end entity to an access controller (e.g., 136 in FIG. 1).

The process 1000 includes computing (at 1004) a trust level for the end entity based on a plurality of factors including a first factor relating to a type of endpoint authentication used by the end entity when connecting to the security system, and a second factor relating to how a protected key for the end entity is generated and protected. Different trust levels are set according to the plurality of factors.

The process 1000 includes adding (at 1006) the computed trust level in a certificate generated for the certificate request.

The process 1000 includes sending (at 1008) the certificate including the computed trust level from the security system to the end entity, the computed trust level affecting access control for the end entity in the computing environment

As used here, a “processing resource” can include one or more hardware processors. An “electronic device” can refer to any or some combination of a computer, a smartphone, a communication node, a storage system, a game appliance, a household appliance, a vehicle, an Internet-of-Things (IoT) device, or any other type of electronic device.

A “storage device” can include any or some combination of a disk-based storage device, a solid state drive, or another type of storage device.

FIGS. 2-7 and 10 show processes with tasks in specific orders. In other examples, the tasks of any of the processes can be performed in a different order, some tasks may be omitted, or other tasks may be added.

A “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on the one or more hardware processing circuits.

A storage medium (e.g., 800 in FIG. 8 or 904 in FIG. 9) can include any or some combination of the following: a semiconductor memory device such as a dynamic or static random access memory (a DRAM or SRAM), an erasable and programmable read-only memory (EPROM), an electrically erasable and programmable read-only memory (EEPROM), or flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a security system to:
receive, at the security system, a certificate request from an end entity for a certificate for access to a computing environment;
compute a trust level for the end entity based on a plurality of factors, the plurality of factors comprising a first factor relating to a protected key for the end entity;
include the computed trust level in a certificate generated for the certificate request; and
send the certificate including the computed trust level from the security system to the end entity, the computed trust level affecting access control for the end entity in the computing environment.

2. The non-transitory machine-readable storage medium of claim 1, wherein the trust level is computed further based on a second factor relating to a remote certification procedure specified in the certificate request.

3. The non-transitory machine-readable storage medium of claim 2, wherein the computed trust level is adjusted by different amounts based on which of a plurality of different remote certification procedures are specified in the certificate request.

4. The non-transitory machine-readable storage medium of claim 1, wherein the instructions upon execution cause the security system to:
compute the trust level by:
setting an initial trust level for the end entity based on a further factor of the plurality of factors, the further factor relating to a type of endpoint authentication used by the end entity when connecting to the security system, and
deriving the computed trust level based on an adjustment from the initial trust level according to remaining one or more factors of the plurality of factors.

5. The non-transitory machine-readable storage medium of claim 4, wherein the type of endpoint authentication is selected from one or more of an anonymous authentication of the end entity, a password-based authentication of the end entity, a registration token-based authentication of the end entity, or a cryptographic device identity-based authentication of the end entity, and wherein the initial trust level is settable to different values for respective different types of endpoint authentications.

6. The non-transitory machine-readable storage medium of claim 1, wherein the instructions upon execution cause the security system to:
compute the trust level further based on a further factor of the plurality of factors, the further factor relating to channel security used for a communication channel between the end entity and the security system.

7. The non-transitory machine-readable storage medium of claim 6, wherein the instructions upon execution cause the security system to:
adjust the computed trust level based on one or more of whether the communication channel is initiated by the security system, a trust level of a registration authority between the end entity and the security system, or information for a network path of the communication channel between the end entity and the security system.

8. The non-transitory machine-readable storage medium of claim 6, wherein the instructions upon execution cause the security system to:
determine a type of security protocol used to implement the channel security,
wherein the computing of the trust level is responsive to the type of security protocol satisfying a criterion relating to one or more of integrity, confidentiality, tamper resistance, or resilience.

9. The non-transitory machine-readable storage medium of claim 1, wherein the first factor relates to one or more of how the protected key is generated or how the protected key is protected.

10. The non-transitory machine-readable storage medium of claim 9, wherein a protection of the protected key is selected from among an open key protection in which the protected key is stored in an insecure storage location, a nonvolatile memory protected key protection in which the protected key is stored in a secure nonvolatile memory, or a security processor key protection in which the protected key is stored in a security processor.

11. The non-transitory machine-readable storage medium of claim 1, wherein the instructions upon execution cause the security system to:
set the computed trust level based on a determination that the protected key is stored in a security processor.

12. The non-transitory machine-readable storage medium of claim 11, wherein the instructions upon execution cause the security system to:
adjust the computed trust level to a selected level of different levels corresponding to the protected key being sealed, the protected key being non-exportable, or the protected key being exportable but encrypted.

13. The non-transitory machine-readable storage medium of claim 11, wherein the instructions upon execution cause the security system to:
determine whether to reject the certificate request based on a key usage indicated in the certificate request for the protected key.

14. The non-transitory machine-readable storage medium of claim 13, wherein the instructions upon execution cause the security system to:
reject the certificate request based on determining that the certificate is for a device identity (DevID) certificate and the key usage is restricted, or reject the certificate request based on determining that the certificate is for an attestation key (AK) certificate and the key usage is not restricted.

15. The non-transitory machine-readable storage medium of claim 13, wherein the instructions upon execution cause the security system to:
reject the certificate request based on determining that the key usage does not allow signing or the key usage is decrypt only.

16. The non-transitory machine-readable storage medium of claim 1, wherein the instructions upon execution cause the security system to:
determine whether a cryptographic identity requested by the certificate request is consistent with an identity in a backing device identity or a registration token; and
reject the certificate request based on determining that the cryptographic identity requested by the certificate request is not consistent with the identity in the backing device identity or the registration token.

17. A security system comprising:
a hardware processor; and
a non-transitory storage medium storing instructions executable on the hardware processor to:
receive a certificate request from an end entity for a certificate for access to a computing environment;
set an initial trust level for the end entity based on a first factor relating to a type of endpoint authentication used by the end entity when connecting to the security system
adjust the initial trust level for the end entity that includes an adjustment based on a second factor relating to a protected key for the end entity, the adjustment producing an adjusted trust level;
include the adjusted trust level in a certificate generated for the certificate request; and
send the certificate including the adjusted trust level from the security system to the end entity, the adjusted trust level affecting access control for the end entity in the computing environment.

18. The security system of claim 17, wherein the adjustment is further based on one or more additional factors selected from among:
a factor relating to a remote certification procedure specified in the certificate request, or
a factor relating to channel security used for a communication channel between the end entity and the security system.

19. A method comprising:
receiving, by a security system comprising a hardware processor, a certificate request from an end entity for a certificate for access to a computing environment;
computing, by the security system, a trust level for the end entity based on a plurality of factors comprising a first factor relating to a type of endpoint authentication used by the end entity when connecting to the security system, and a second factor relating to how a protected key for the end entity is generated and protected;
include the computed trust level in a certificate generated for the certificate request; and
send the certificate including the computed trust level from the security system to the end entity, the computed trust level affecting access control for the end entity in the computing environment.

20. The method of claim 19, wherein the trust level is computed further based on a third factor relating to a remote certification procedure specified in the certificate request, wherein the computed trust level is adjusted by different amounts based on which of a plurality of different remote certification procedures are specified in the certificate request.
